(19) United States
(12) Patent Application Publication
(10) Pub. No.: US 2005/0036892 A1
(43) Pub. Date: Feb. 17, 2005

(54) Method for applying metallurgical coatings to gas turbine components

(76) Inventor: Richard Bajan, Simpsonville, SC (US)

Correspondence Address: EDWARDS & ANGELL, LLP, P.O. BOX 55874, BOSTON, MA, 02205, US

(21) Appl. No.: 10/642,368

(22) Filed: Aug. 15, 2003

(51) Int. Cl. B05D 3/04; B63H 1/26

(52) U.S. Cl. 416/241 R; 427/348; 427/446; 427/402

(57) ABSTRACT

A method is disclosed for applying a metallurgical coating to a superalloy substrate that includes the steps directing a water jet having a sufficient pressure against the surface of the superalloy substrate for a sufficient time period to modify the surface morphology of the substrate in a such a manner so that the surface roughness and surface volume of the substrate are increased at a microscopic and macroscopic level, and depositing a metallurgical coating on the modified surface of the substrate using a high velocity oxygen fuel spray.

### BACKGROUND OF THE INVENTION

1. Field of the Invention

The subject invention is directed to a method for applying metallurgical coatings to a superalloy substrate, and more particularly, to a method for preparing the surface of a gas turbine component and subsequently depositing a metallurgical coating on the surface of the component.

2. Background of the Related Art

The use of protective metallurgical coatings to increase the life of a gas turbine component is well known in the art. A variety of techniques have been employed to apply such coatings. These processes include arc wire, atmospheric plasma spray, high velocity oxygen fuel (HVOF) and low-pressure plasma spray (LPPS). To date, the highest quality metallic overlay coatings have been considered to be obtainable only with the LPPS process.

In the LPPS process, a plasma spray torch is utilized in a low-pressure chamber, wherein an inert-atmospheric gas is allowed to flow between a tungsten cathode and a water-cooled copper anode. An electric arc initiated between the cathode and anode ionizes the gas, creating a plasma stream. Metallic powder is then introduced into the plasma stream and the effluent is applied to the surface of a component. Prior to deposition of the LPPS coating, the component must first be surface cleaned using a Reverse Transferred Arc (RTA). This removes residual oxides, abrasive grit and other contaminants from the surface. Consequently, the LPPS process is cost intensive.

High velocity oxygen fuel (“HVOF”) spray coating is a less expensive process than the more often used LPPS process. In HVOF spray coating, metal powder, typically an alloy powder, is applied by melting the powder at flame temperatures that are well below the temperatures required to melt ceramics. The melted powder is directed at a substrate and has high particle velocities. The HVOF process produces a densely deposited coating.

The HVOF process is often used to deposit a metallic layer over the substrate of an article that is used in operating environments that are thermally and chemically hostile, such as the environment within a gas turbine engine. The metallic layer is formed from high temperature, oxidation-resistant alloys including nickel-based superalloys, cobalt-based superalloys and MCrAlY alloys in which M can be iron, cobalt, nickel and combinations thereof.

When MCrAlY alloys are deposited as metallic layers for turbine section components of gas turbine engines, the HVOF process is preferred because it can provide a suitable coating at less expense. However, in order to apply a metallic layer to a substrate using the HVOF process that will properly adhere at elevated temperatures and under high stresses it is necessary to properly prepare the substrate prior to metal application. Substrates that will utilize a metallic layer applied by the HVOF process are generally roughened to improve the adhesion of the layer applied by the HVOF process. It is believed that the rough surface finish is initially required to provide a mechanical adhesion component to the attachment of the metallic layer to the substrate. The lower temperature of application of a layer using thermal spray processes such as HVOF creates a weak metallurgical bond, and the additional strength required for the bonding of the layer to the substrate may not be fully developed initially because of the lower application temperatures. This is a distinction from other processes such as the LPPS process in which a stronger metallurgical bond is developed between the substrate and the applied coat.

The preparation of a substrate for application of the metallic layer by the HVOF process is generally accomplished by grit blasting. The substrate to which the metallic layers have been applied are then heat-treated to promote diffusion. The heat treatment further develops the metallurgical bond of the HVOF-applied metallic layer to the substrate. Thus, the final superior adhesion of the coating layer is a result of both mechanical and metallurgical bonding. However, it has been found that grit blasting can embed blasting media in the surface of the substrate. Furthermore, the embedded media can adversely affect the adhesion of the coating to the substrate. Too large a concentration of grit at the interface between the HVOF-applied layer and the substrate can impede the diffusion and act as stress risers that may contribute to delamination of the applied layer as the coating is cycled in service.

It would be beneficial therefore, to provide a method of applying a metallurgical coating to a superalloy substrate by the HVOF process, which overcomes the deficiencies and disadvantages of prior art techniques, including the use of grit blasting to prepare the surface of the substrate prior to the application of the coating by the HVOF process.

### SUMMARY OF THE INVENTION

The subject invention is directed to a new and useful method for applying a metallurgical coating to a superalloy substrate which includes the steps of directing a water jet having a sufficient pressure against the surface of the superalloy substrate for a sufficient time period to modify the surface morphology of the substrate in a such a manner so that the surface roughness and surface volume of the substrate are increased at a microscopic and macroscopic level, and depositing a metallurgical coating on the modified surface of the substrate by high velocity oxygen fuel spray.

The method of the subject invention has been employed to achieve a metallurgical coating layer having a thickness ranging to and in excess of 0.500 inches. It is envisioned that the metallurgical coating deposited on the superalloy substrate can be a platinum aluminide metallurgical coating, or a MCrAlY metallurgical coating, including, for example, CoCrAlY, NiCrAlY and NiCoCrAIY.

In an embodiment of the subject invention, the method further includes the step of grit blasting the surface of the substrate to increase surface roughness prior to treating the surface with a high-pressure water jet. In addition, the method includes the steps of heat treating the coated substrate under vacuum and optionally subjecting the coated substrate to hot isostatic pressing.

In the water jet surface preparation step, a water jet is directed at the surface of the substrate at a pressure of about between 45,000 psi to 60,000 psi, and more preferably at about 55,000 psi. Preferably, the water jet is directed at the surface through a ruby orifice having a diameter of about between 0.010″ to 0.016″, and the water jet traverses the surface of the substrate at a sweep rate of about between 25″ to 100″ per minute, at a stand off distance of about between 0.375″ to about 1.0″ with an indexed step-over distance of about between 0.030″ to 0.10″. This process may be repeated as many as eight times to achieve a desired surface roughness prior to depositing the coating of the surface.

The subject invention is also directed to a method for applying a metallurgical coating to a superalloy substrate that includes the steps of roughening the surface of the superalloy substrate through grit blasting, directing a water jet having a sufficient pressure against the roughened surface of the substrate for a sufficient time period to modify the surface morphology of the substrate, and depositing a metallurgical coating on the modified surface of the substrate by high velocity oxygen fuel spray. The method further includes the steps of vacuum heat treating the coated substrate and optionally subjecting the coated substrate to hot isostatic pressing.

The subject invention is also directed to a method for applying a two-layer metallurgical coating system to a superalloy substrate. This method includes the steps of directing a water jet having a sufficient pressure against the surface of the superalloy substrate for a sufficient time period to modify the surface morphology of the substrate, and then depositing a first metallurgical coating layer onto the modified surface of the substrate by high velocity oxygen fuel spray. The method further includes the steps of directing a water jet having a sufficient pressure against the surface of the first metallurgical coating layer for a sufficient time period to modify the surface morphology of the first metallic coating layer, and then depositing a second coating layer onto the modified surface of the first metallurgical coating layer. The method may further include the step of grit blasting the surface of the substrate to increase surface roughness prior to treating the surface of the substrate with a water jet.

In one embodiment of this two-layer coating method, the step of depositing a second coating layer onto the modified surface of the first metallurgical coating layer includes deposition of a second metallurgical coating layer onto the modified surface of the first metallurgical coating layer by high velocity oxygen fuel spray. In another embodiment, the step of depositing a second coating layer onto the modified surface of the first metallurgical coating layer includes deposition of a ceramic coating layer onto the modified surface of the first metallurgical coating layer by plasma thermal spray. In this instance, the second coating layer is a 6-8 weight % Yttria stabilized zirconium oxide ceramic thermal barrier coating. Preferably, the method further includes the step of vacuum heat treating the coated substrate and optionally subjecting the coated substrate to hot isostatic pressing prior to deposition of the second coating layer.

The subject invention is also directed to a method for applying a three-layer metallurgical coating system to a superalloy substrate. This method includes the steps of directing a water jet having a sufficient pressure against the surface of the superalloy substrate for a sufficient time period to modify the surface morphology of the substrate, depositing a first metallurgical coating layer onto the modified surface of the substrate by high velocity oxygen fuel spray, and then directing a water jet having a sufficient pressure against the surface of the first metallurgical coating layer for a sufficient time period to modify the surface morphology of the first metallurgical coating layer. The method further includes the steps of depositing a second metallurgical coating layer onto the modified surface of the first metallurgical coating layer by high velocity oxygen fuel spray, directing a water jet having a sufficient pressure against the surface of the second metallurgical coating layer for a sufficient time period to modify the surface morphology of the second coating layer, and then depositing a third coating layer onto the modified surface of the second metallurgical coating layer. The method may further include the step of grit blasting the surface of the substrate to increase surface roughness prior to treating the surface of the substrate with a water jet.

In this three-layer coating method, the step of depositing a third coating layer onto the modified surface of the second metallurgical coating layer includes deposition of a ceramic coating layer onto the modified surface of the second metallurgical coating layer by plasma thermal spray. The deposition of at least one of the first and second metallurgical coating layers includes the step of depositing either a platinum aluminide metallurgical coating, or a MCrAlY metallurgical coating. Preferably, the method further includes the step of vacuum heat treating the coated and optionally subjecting the coated substrate to hot isostatic pressing prior to deposition of the second coating layer.

These and other aspects of the method of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to make and use the method and system of the present invention, embodiments thereof will be described in detail hereinbelow with reference to the drawings, wherein:

FIG. 1 is a flow chart illustrating the steps for applying a metallurgical coating to a superalloy substrate in accordance with a preferred embodiment of the subject invention;

FIG. 2 is a flow chart illustrating the steps for applying a two-layer metallurgical coating system to a superalloy substrate in accordance with another preferred embodiment of the subject invention;

FIG. 3 is a flow chart illustrating the steps for applying a three-layer metallurgical coating system to a superalloy substrate in accordance with another preferred embodiment of the subject invention;

FIG. 4 is an illustration of the high pressure water jet process which forms part of the superalloy coating method of the subject invention;

FIG. 5 is an illustration of the high velocity oxygen fuel spray coating process, which forms part of the superalloy coating method of the subject invention;

FIG. 6 is a photograph of a superalloy turbine component wherein the cold worked surface of the component has been removed by high pressure water jet treatment in accordance with the subject invention, revealing the directionally solidified grain structure thereof;

FIG. 7 is a photograph of another superalloy component wherein the cold worked surface of the component has been removed by high pressure water jet treatment in accordance with the subject invention, revealing the equi-axed grain structure thereof;

FIG. 8 is a three-dimensional representation of the grit blasted surface of a superalloy substrate taken using a vertically scanning interference microscope;

FIG. 9 is a three-dimensional representation of the grit blasted surface of a superalloy substrate that has been further modified by high pressure water jet, taken using a vertically scanning interference microscope;

FIG. 10 is a photomicrograph of the grit blasted surface of a superalloy substrate which is shown to be predominantly flat and planar on a microscopic layer, providing a relatively low volume of surface area for bonding with the HVOF coating;

FIG. 11 is a photomicrograph of the surface of FIG. 10 after it has been treated by high pressure water jet, which provides a vastly increased amount of surface area for bonding with the HVOF coating;

FIG. 12 is a photomicrograph showing the interface between an HVOF deposited metallurgical coating and the surface of a substrate that has been modified solely by grit blasting;

FIG. 13 is a photomicrograph showing the interface between an HVOF deposited metallurgical coating and the surface of a substrate that has been modified by grit blasting and high pressure water jet; and

FIG. 14 is a photomicrograph showing the interface between an HVOF deposited metallurgical coating and the surface of a substrate that has been modified solely by high pressure water jet.

### DETAILED DESCRIPTION OF THE PREFERRED EMBODIMENTS

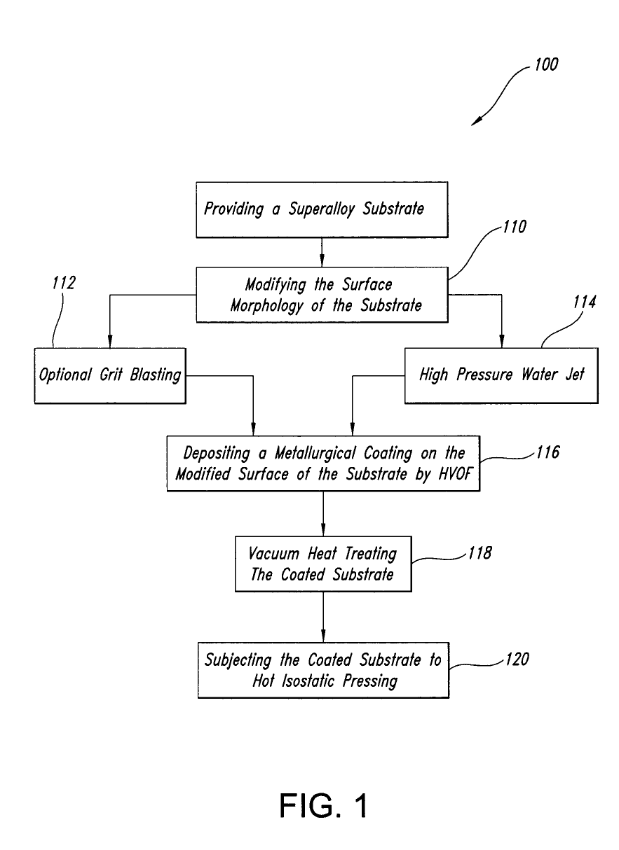

Referring now to the drawings, photographs and images accompanying this specification, there is illustrated in FIG. 1 a flow chart designated generally by reference numeral 100 illustrating the steps for applying a metallurgical coating to a superalloy substrate in accordance with a preferred embodiment of the subject invention.

Initially at step 110, the surface morphology of the superalloy substrate is modified. This is accomplished at step 112 optionally, by subjecting the surface of the substrate to grit blasting. In the application of thermal spray coatings, regardless of the particular technique, it has been a common practice to clean, roughen or abrade by blasting a grit such as small ground pieces of glass, aluminum oxide, silicon carbide, etc., to roughen the surface. It is known to utilize a commercial grit material, e.g., aluminum oxide, glass, silicon carbide or chilled iron of −30/+80 mesh size. Grit blasting roughens the surface so as to provide increased surface area for adhesion and mechanical bonding between the base metal and the thermal spray coating. Grit blasting provides an inexpensive yet effective method of achieving a uniform surface roughness.

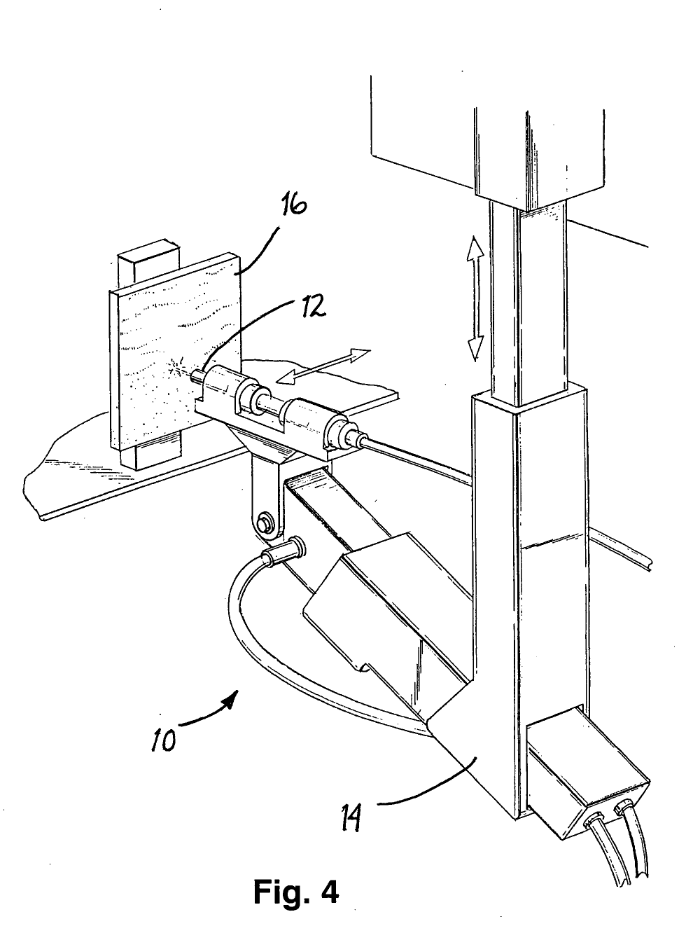

At step 114, the grit blasted surface is cleaned and further roughened by a high-pressure water jet treatment, as illustrated for example in FIG. 4. It is envisioned and well within the scope of the subject invention that the surface morphology of the substrate may be modified on a macroscopic and microscopic level solely by water jet treatment, excluding the optional step of grit blasting. A suitable water jet apparatus for performing this task is manufactured by Flow International Corporation of Kent, Wash., and shown in FIG. 4. The apparatus 10 supplies pressurized water at about between 45,000 psi to 65,000 psi. In accordance with the subject invention, the pressurized water is forced through a nozzle 12 at a pressure of about 55,000 psi. The nozzle preferably has a ruby orifice with a diameter of about between 0.010″ to 0.016″. Preferably, using a six-axis computer numerical control (CNC) positioning machine 14, which can provide precise positioning relative to the complex surfaces of a turbine component, the water jet traverses the surface of the substrate 16 at a rate of about between 25″ to 100″ per minute, at a stand off distance (the distance from the edge of the nozzle head to the surface of the substrate) of about between 0.375″ to about 1.0″ with a step-over distance of about between 0.030″ to 0.10″. This process step is repeated as many as eight times depending upon the substrate material.

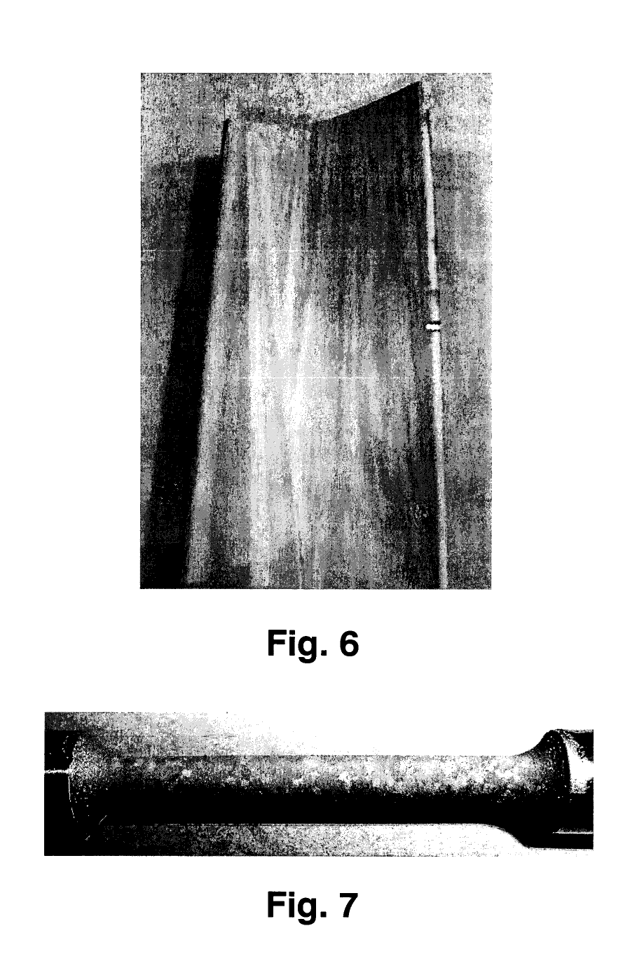

The high-pressure water jet surface treatment supercleans the grit-roughened surface, and more importantly, modifies the surface morphology of the substrate. In particular, the surface morphology of the substrate is modified in such a manner so that the surface roughness and surface volume of the substrate are increased at a microscopic and macroscopic level. Thus, the high-pressure water jet removes the cold worked surface of the substrate and exposes the grain structure of the superalloy material to achieve super micro-roughness, as best seen in FIGS. 6 and 7. In particular, FIG. 6 illustrates the directionally solidified grain structure of a water jet prepared superalloy turbine component wherein the cold worked surface has been removed, and FIG. 7 illustrates the equi-axed grain structure of a water jet prepared superalloy component.

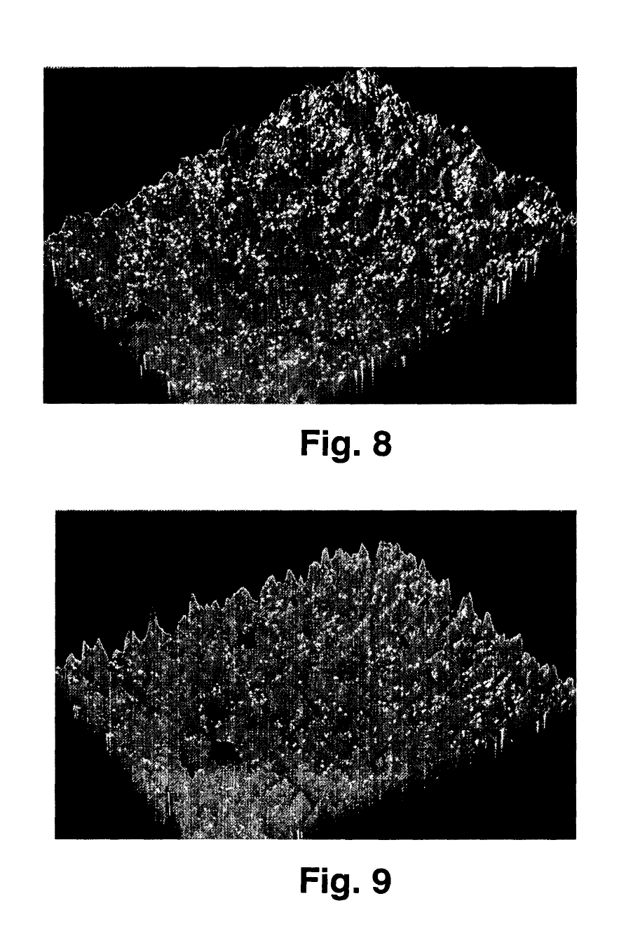

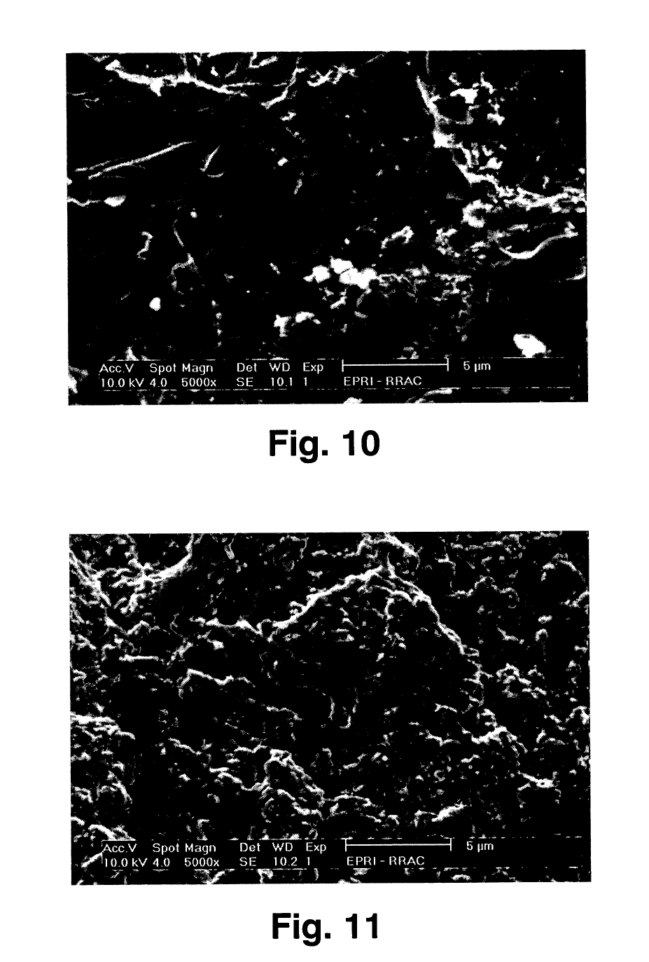

FIGS. 8 and 9 are three-dimensional interferometric images that show the difference between the roughnesses of a grit blasted surface (FIG. 8) and a surface that has been grit blasted and treated by high-pressure water jet (FIG. 9). FIG. 10 is a photomicrograph of the grit blasted surface of a superalloy substrate which is shown to be predominantly flat and planar in nature, on a microscopic level, providing a relatively low volume of surface area for boding with the HVOF coating. In contrast, FIG. 11 is a photomicrograph of the same surface after it has been treated by high-pressure water jet. There is a high degree of “super micro-roughness” which provides a vastly increased amount of surface area for bonding with the HVOF coating. From these images, it is clear that the water jet treatment increases the surface roughness and surface volume of the substrate.

The following table 1.0 illustrates the increased surface roughness achieved by the water jet surface preparation following grit blasting. The data was obtained using a WYKO NT-2000 vertically scanning interference microscope, which is a non-contact optical profiler. The samples were measured with a 5× magnification objective, which profiles 1.2 mm×0.9 mm area with a spatial separation interval of 3.29 microns. As referenced in table 1.0, Rₐ is the roughness average and is the mean height calculated over the entire measured array. R_{q} is the root mean square (RMS) roughness or the root mean square average of the measured height deviations taken within the evaluation length or area and measured from the mean linear surface. Rₜ is the maximum height of the profile which is the vertical distance between the highest and lowest pints of the surface within the evaluation length. In other words, it is the maximum peak-to-valley height of the profile calculated over the entire measured data array.

TABLE 1.0

| Sample | Preparation | Rₐ (μm) | R_{q} (μm) | Rₜ (μm) |
|---|---|---|---|---|
| 1 | Grit blasted | 4.7 | 5.27 | 45.05 |
| 2 | Grit blasted | 5.26 | 6.65 | 52.71 |
| | & Water Jet | | | |

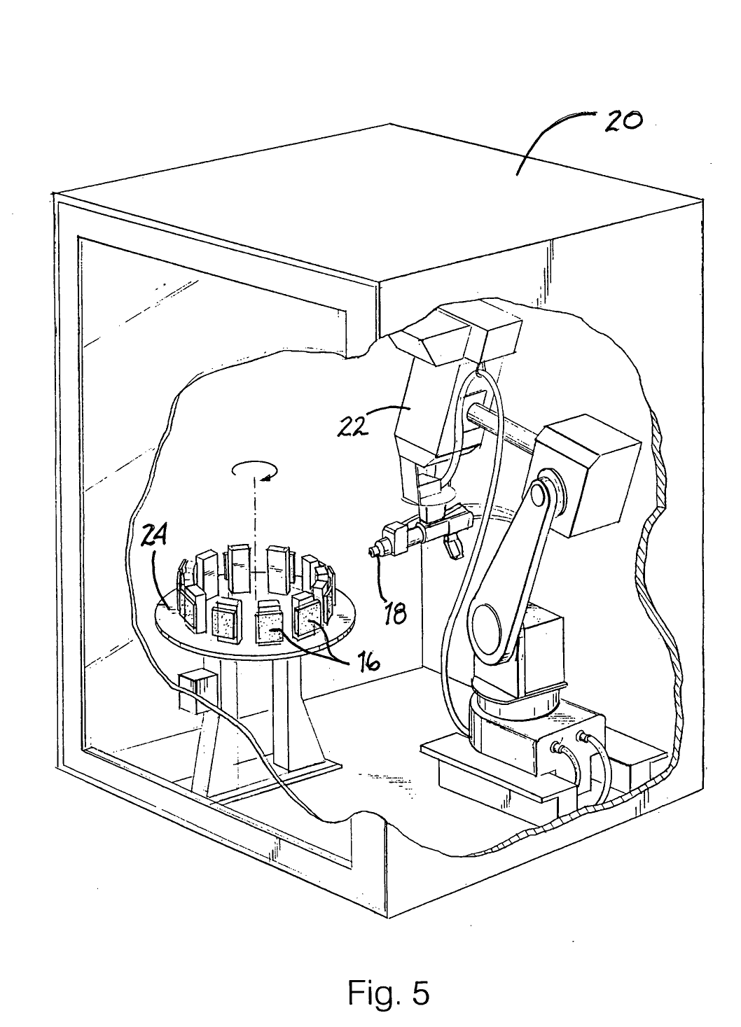

At step 116, a metallurgical coating is deposited on the modified surface of the substrate by high velocity oxygen fuel spray (HVOF), as illustrated for example in FIG. 5. It is envisioned that the metallurgical coating deposited on the superalloy substrate(s) can be a platinum aluminide metallurgical coating, or a MCrAlY metallurgical coating, including, for example, CoCrAlY, NiCrAlY and NiCoCrAlY. In the HVOF process, a fuel gas and oxygen are used to create a combustion flame at 2500° to 3100° C. As shown in FIG. 5, the combustion takes place at in a chamber 20 at a very high pressure and a supersonic gas stream forces the coating material (e.g., powdered IN738) through a small-diameter barrel 18 at very high particle velocities. The barrel 18 is mounted on a CNC positioning machine 22, and the substrate(s) 16 are mounted on a rotary support table 24 within chamber 20.

The HVOF process results in extremely dense, well-bonded coatings. Typically, HVOF coatings can be formed nearly 100% dense, with at a porosity of about 0.5%. The high particle velocities obtained using the HVOF process results in relatively better bonding between the coating material and the substrate, as compared with other coating methods such as the conventional plasma spraying or arc wire and low velocity combustion thermal spray processes. The HVOF process forms a bond between the coating material and the substrate that occurs primarily through mechanical adhesion at a bonding interface. As will be described below with reference to several photomicrographs, this mechanical bond is converted to a metallurgical bond by creating a diffusion bond between the coating material and the substrate. The diffusion bond does not have the interface boundary, which is usually the site of failure.

As noted above, the bonding mechanism of an as-deposited HVOF metallic coating to a superalloy substrate is purely mechanical in nature. The coating particles are merely mechanically interlocked with the roughened surface. Thus, at step 118, the coated substrate is vacuum heat-treated. Vacuum heat treatment produces an intimate metallurgical and chemical bond between the HVOF coating and superalloy substrate. Mechanisms including diffusion, and elemental migration occur between the coating and substrate when the component is held between 1975° F.-2200° F. for 2 to 4 hours in a protective vacuum atmosphere.

Vacuum heat treatment produces an approximate 0.0001″-0.001″ thick diffusion zone between the coating and substrate. Normally following the diffusion cycle, the component receives a precipitation age hardening vacuum heat treatment cycle to restore the mechanical strength properties of the superalloy. This is required for gamma-prime hardenable alloys such as the family of alloys similar to Inconel 738. The age hardening cycle for IN738 is typically 1550° F. for 24 hours.

Depending upon the type of coating and component application, after vacuum heat treatment, the coated substrate may be subjected to Hot Isostatic Pressing (HIP) at step 120. This optional step serves to densify and reduce the porosity of the HVOF coating, and simultaneously eliminate or “heal” any residual porosity in the superalloy casting to which the HVOF coating is applied. The HIP treatment is performed on the coated substrate to obtain a metal product having the desired finished dimensions and diffusion bonding between the coating material and the substrate. More particularly, the HIP treatment process is performed on a HVOF coated substrate to convert the adhesion bond, which is merely a relatively weaker mechanical bond, to a diffusion bond, which is a relatively stronger metallurgical bond. If the coating material and the substrate are comprised of the same metal composition (e.g., IN 738), then the diffusion bonding results in a seamless transition between the substrate and the coating. In contrast, conventional plasma spray coating results in a relatively weak bond between the coating and the substrate. The bond is primarily due to a mechanical adhesion bond that occurs relatively locally within a boundary interface.

A typical HIP treatment cycle involves the simultaneous application of heat and high pressure, and has become a standard production process in many industries. In a HIP unit, a high temperature furnace is enclosed in a pressure vessel. Work pieces are heated and an inert gas, generally argon, applies uniform pressure. The appropriate treatment parameters, such as temperature, pressure and process time are all controlled to achieve the optimum material properties, and are selected depending on the coating and the substrate. Typically, the part is heated to 0.6-0.8 times the melting point of the material comprising the part, and subjected to pressures on the order of 0.1 to 0.5 times the yield strength of the material. For example, HIP treatment parameters may include a heat cycle at 2200° F., for 2-4 hours at a pressure of 15,000 psi, using an argon atmosphere.

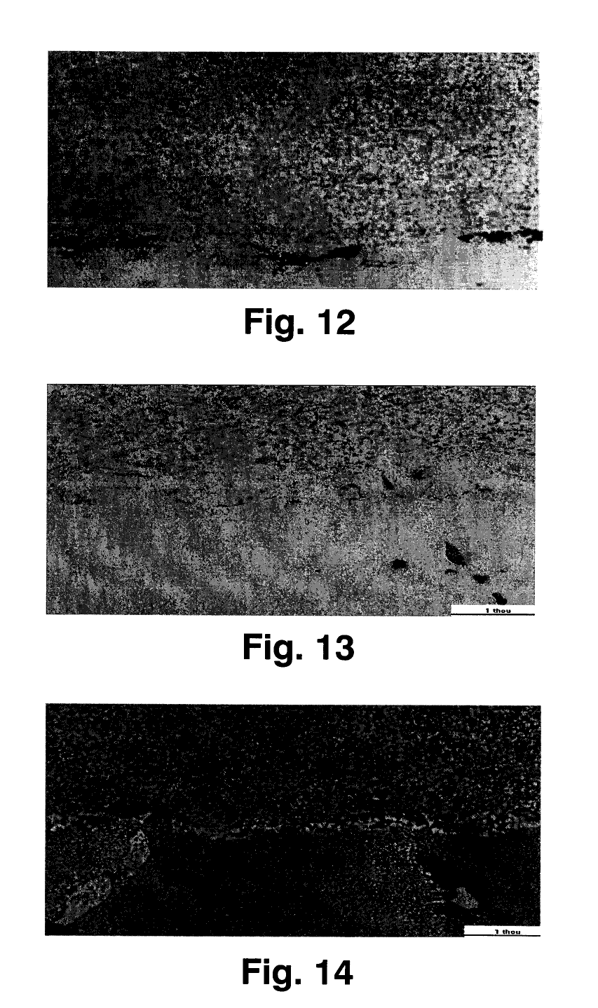

FIGS. 12 through 14 are photomicrographs showing the differences between the quality of the interface between an HVOF deposited coating and a superalloy substrate that has been treated solely by grit blasting, by grit blasting and water jet, and solely by water jet. As shown, in FIG. 12, the interface between the metallurgical coating and the grit blasted surface of the superalloy substrate contains entrapped residual contaminants providing an inferior metallurgical bond. In contrast, the interface between the metallurgical coating and the grit blasted/water jet treated surface of the superalloy substrate shown in FIG. 13 has no residual grit, thus providing an excellent metallurgical bond. Similarly, the interface between the metallurgical coating and the surface of the superalloy substrate treated solely by high-pressure water jet, shown in FIG. 14, is virtually free of contaminants, thus providing a superior metallurgical bond.

The subject invention is also directed to a gas turbine component manufactured in accordance with the methods disclosed herein. Such gas turbine components include, for example, blades, vanes, buckets, shrouds and similar components, which form part of the hot section of the engine. The thickness of the metallurgical coatings applied to the roughened surfaces of such components can range from 0.001″ to 0.100″.

The coating method of the subject invention has been utilized to achieve a metallurgical coating having a thickness in excess of 0.500″. More particularly, the method of the subject invention was employed to coat a set of superalloy substrates consisting of IN 718 plates measuring 2.625″×4.75″×0.300″. In this instance, the surface of each substrate was initially grit blasted with a 36 mesh aluminum oxide at 80 psi, and then waterjet treated at 55,000 psi, at a sweep rate of 75″/min., with a indexed step-over distance of 0.075 in. and a stand-off distance of 0.625″ for two complete passes. The powdered superalloy used to coat the substrates was PAC IN 738 HV and the HVOF cell had a 28.5 carrier flow, set at 160 psi with a 20 psi vibrator. The rotary substrate support table within the cell was set at 171 RPM, and the spray speed was set at 10 mm/sec. A 16.5″ diameter fixture was used to mount the substrate plates and the spray distance was set at 11.0″ (see FIG. 5). A total of 673 spray cycles occurred, resulting in approximately 0.592″ of total coating. The completed substrates were then heat treated at 2200° F.

Two-Layer Coating System

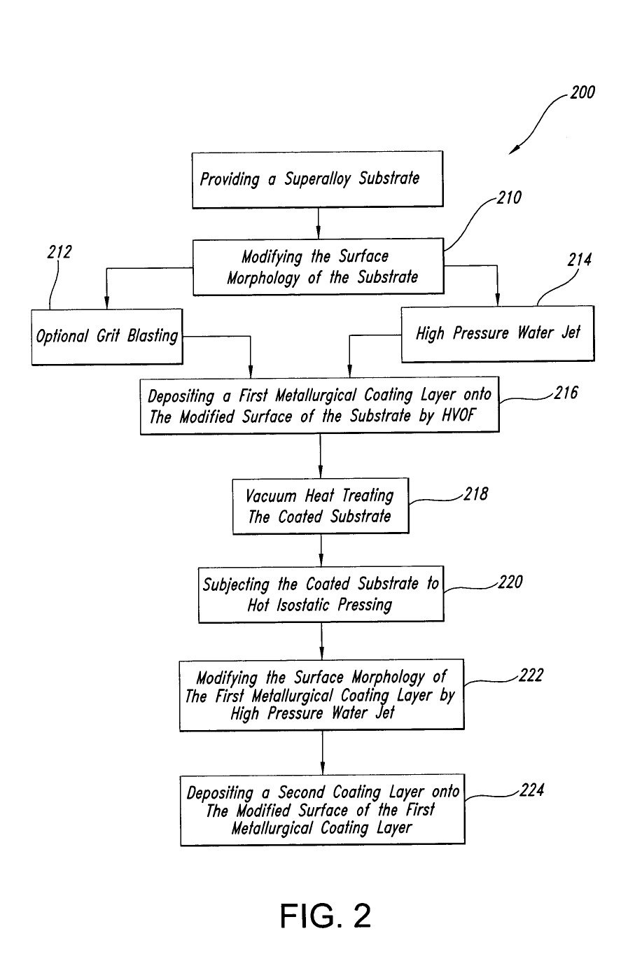

Referring to FIG. 2, there is illustrated a flowchart designated generally by reference numeral 200 that outlines the process steps for applying a two-layer coating system to a superalloy substrate in accordance with a preferred embodiment of the subject invention. Initially, at step 210, the surface of the superalloy substrate is roughened. This may involve both grit blasting at step 212 and water jet surface treatment as step 214, or only water jet surface treatment at step 214. At step 214, a water jet having a sufficient pressure is directed against the surface of the superalloy substrate for a sufficient time period to modify the surface morphology of the substrate and more particularly to achieve super-micro roughness.

Thereafter, at step 216, a first metallurgical coating layer is deposited onto the modified surface of the substrate by high velocity oxygen fuel spray. It is envisioned that the first metallurgical coating layer deposited on the superalloy substrate can be a platinum aluminide metallurgical coating, or a MCrAlY metallurgical coating, including, for example, CoCrAlY, NiCrAlY and NiCoCrAlY. The coated substrate is then subjected to vacuum heat treatment at step 218 and optional hot isostatic pressing at step 220.

Then, at step 222, a water jet having a sufficient pressure is directed against the surface of the first metallurgical coating layer for a sufficient time period to modify the surface morphology of the first metallic coating layer. At step 224, a second coating layer is deposited onto the modified surface of the first metallurgical coating layer. It is envisioned that the second coating layer can be a second metallurgical coating layer deposited by high velocity oxygen fuel (HVOF) spray. In this instance, the second metallurgical coating layer can be a platinum aluminide metallurgical coating, or a MCrAlY metallurgical coating, including, for example, CoCrAlY, NiCrAlY and NiCoCrAlY.

Those skilled in the art will readily appreciate that the first and second metallurgical layers may consist of the same or different metallurgical coatings. Alternatively, the second coating layer may be a ceramic thermal barrier coating layer deposited by plasma thermal spray over the first metallurgical coating layer.

Three-Layer Coating System

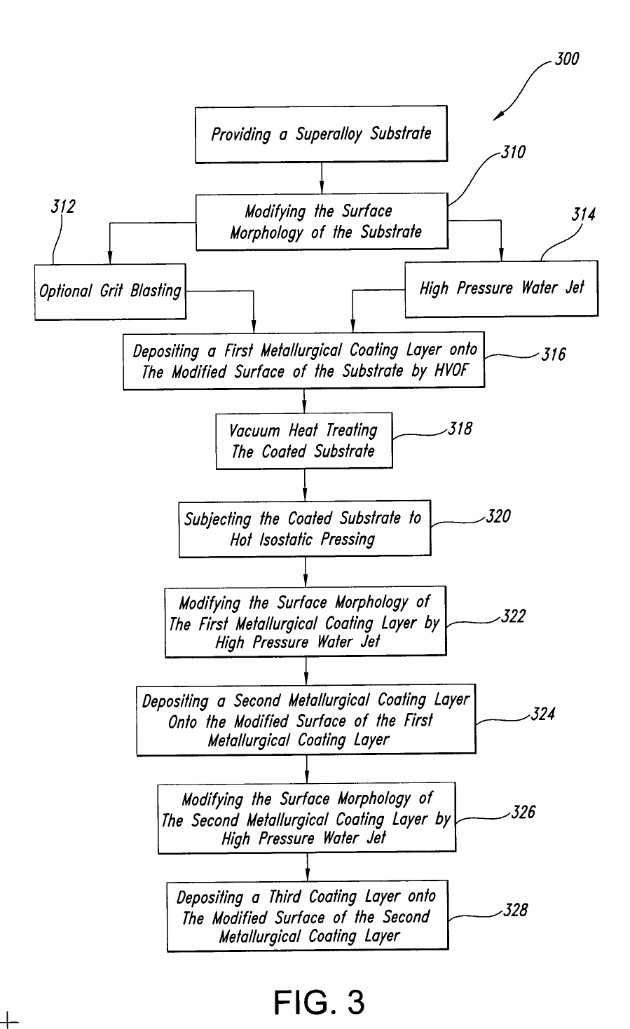

Referring to FIG. 3, there is illustrated a flowchart designated generally by reference numeral 300 that outlines the process steps for applying a two-layer coating system to a superalloy substrate in accordance with a preferred embodiment of the subject invention.

Initially, at step 310, the surface of the superalloy substrate is roughened. This may involve both grit blasting at step 312 and water jet surface treatment as step 314, or only water jet surface treatment at step 314. At step 314, a water jet having a sufficient pressure is directed against the surface of the superalloy substrate for a sufficient time period to modify the surface morphology of the substrate and more particularly to achieve super-micro roughness.

Thereafter, at step 316, a first metallurgical coating layer is deposited onto the modified surface of the substrate by high velocity oxygen fuel spray. It is envisioned that the first metallurgical coating layer deposited on the superalloy substrate can be a platinum aluminide metallurgical coating, or a MCrAlY metallurgical coating, including, for example, CoCrAlY, NiCrAlY and NiCoCrAlY. The coated substrate is then subjected to vacuum heat treatment at step 318 and optional hot isostatic pressing at step 320.

Then, at step 322, a water jet having a sufficient pressure is directed against the surface of the first metallurgical coating layer for a sufficient time period to modify the surface morphology of the first metallic coating layer. At step 324, a second metallurgical coating layer is deposited onto the modified surface of the first metallurgical coating layer by high velocity oxygen fuel (HVOF) spray. The second metallurgical coating layer can be a platinum aluminide metallurgical coating, or a MCrAlY metallurgical coating, including, for example, CoCrAlY, NiCrAlY and NiCoCrAlY. Those skilled in the art will readily appreciate that the first and second metallurgical layers of the three-layer coating system may consist of the same or different metallurgical coatings.

Thereafter, at step 326, a water jet having a sufficient pressure is directed against the surface of the second metallurgical coating layer for a sufficient time period to modify the surface morphology of the second coating layer. At step 328, the third coating layer is deposited onto the modified surface of the second metallurgical coating layer. The third coating layer is preferably a ceramic coating layer deposited by plasma thermal spray, and more preferably, a 6-8 weight % Yttria stabilized zirconium oxide ceramic thermal barrier coating layer.

Although the system and method of the subject invention have been described with respect to preferred embodiments, those skilled in the art will readily appreciate that changes and modifications may be made thereto without departing from the spirit and scope of the subject invention as defined by the appended claims.

1. A method for applying a metallurgical coating to a superalloy substrate comprising the steps of:
a) directing a water jet having a sufficient pressure against the surface of the superalloy substrate for a sufficient time period to modify the surface morphology of the substrate in a such a manner so that the surface roughness and surface volume of the substrate are increased at a microscopic and macroscopic level; and
b) depositing a metallurgical coating on the modified surface of the substrate by high velocity oxygen fuel spray.

2. A method according to claim 1, including depositing a metallurgical coating layer having a thickness ranging to and in excess of 0.500 inches.

3. A method according to claim 1, further comprising the step of grit blasting the surface of the substrate to increase surface roughness prior to treating the surface with a water jet.

4. A method according to claim 1, further comprising the step of heat treating the coated substrate.

5. A method according to claim 4, wherein the step of heat treating includes heat treating the coated substrate under vacuum.

6. A method according to claim 5, further comprising the step of subjecting the coated substrate to hot isostatic pressing.

7. A method according to claim 1, wherein the step of directing a water jet at the surface of the substrate includes directing a water jet at the surface at a pressure of about 55,000 psi.

8. A method according to claim 1, wherein the step of depositing a metallurgical coating on the surface of the substrate includes depositing a platinum aluminide metallurgical coating onto the surface of the substrate.

9. A method according to claim 1, wherein the step of depositing a metallurgical coating on the surface of the substrate includes depositing a MCrAlY metallurgical coating onto the surface of the substrate, wherein M is selected from the group consisting of Co, Ni and NiCo.

10. A method for applying a metallurgical coating to a superalloy substrate comprising the steps of:
a) roughening the surface of the superalloy substrate through grit blasting;
b) directing a water jet having a sufficient pressure against the roughened surface of the substrate for a sufficient time period to modify the surface morphology of the substrate; and
c) depositing a metallurgical coating on the modified surface of the substrate by high velocity oxygen fuel spray.

11. A method according to claim 10, further comprising the step of vacuum heat treating the coated substrate.

12. A method according to claim 11, further comprising the step of subjecting the coated substrate to hot isostatic pressing.

13. A method according to claim 10, wherein the step of depositing a metallurgical coating on the surface of the substrate includes depositing a platinum aluminide metallurgical coating onto the surface of the substrate.

14. A method according to claim 10, wherein the step of depositing a metallurgical coating on the surface of the substrate includes depositing a MCrAlY metallurgical coating onto the surface of the substrate, wherein M is selected from the group consisting of Co, Ni and NiCo.

15. A method for applying a two-layer metallurgical coating system to a superalloy substrate comprising the steps of:
a) directing a water jet having a sufficient pressure against the surface of the superalloy substrate for a sufficient time period to modify the surface morphology of the substrate;
b) depositing a first metallurgical coating layer onto the modified surface of the substrate by high velocity oxygen fuel spray;
c) directing a water jet having a sufficient pressure against the surface of the first metallurgical coating layer for a sufficient time period to modify the surface morphology of the first metallic coating layer; and
d) depositing a second coating layer onto the modified surface of the first metallurgical coating layer.

16. A method according to claim 15, further comprising the step of grit blasting the surface of the substrate to increase surface roughness prior to treating the surface of the substrate with a water jet.

17. A method according to claim 15, wherein the step of depositing a second coating layer onto the modified surface of the first metallurgical coating layer includes deposition of a second metallurgical coating layer onto the modified surface of the first metallurgical coating layer by high velocity oxygen fuel spray.

18. A method according to claim 15, wherein the step of depositing a second coating layer onto the modified surface of the first metallurgical coating layer includes deposition of a ceramic coating layer onto the modified surface of the first metallurgical coating layer by plasma thermal spray.

19. A method according to claim 18, wherein the step of depositing a second coating layer includes deposition of a 6-8 weight % Yttria stabilized zirconium oxide ceramic thermal barrier coating over the modified surface the first metallurgical coating layer.

20. A method according to claim 17, wherein the deposition of at least one of the first and second metallurgical coating layers includes the step of depositing a platinum aluminide metallurgical coating.

21. A method according to claim 17, wherein the deposition of at least one of the first and second metallurgical coating layers includes the step of depositing a MCrAlY metallurgical coating, wherein M is selected from the group consisting of Co, Ni and NiCo.

22. A method according to claim 15, further comprising the step of vacuum heat treating the coated substrate prior to deposition of the second coating layer.

23. A method according to claim 22, further comprising the step of subjecting the coated substrate to hot isostatic pressing prior to deposition of the second coating layer.

24. A method for applying a three-layer metallurgical coating system to a superalloy substrate comprising the steps of:
a) directing a water jet having a sufficient pressure against the surface of the superalloy substrate for a sufficient time period to modify the surface morphology of the substrate; and
b) depositing a first metallurgical coating layer onto the modified surface of the substrate by high velocity oxygen fuel spray;
c) directing a water jet having a sufficient pressure against the surface of the first metallurgical coating layer for a sufficient time period to modify the surface morphology of the first metallurgical coating layer;
d) depositing a second metallurgical coating layer onto the modified surface of the first metallurgical coating layer by high velocity oxygen fuel spray;
e) directing a water jet having a sufficient pressure against the surface of the second metallurgical coating layer for a sufficient time period to modify the surface morphology of the second coating layer; and
f) depositing a third coating layer onto the modified surface of the second metallurgical coating layer.

25. A method according to claim 24, further comprising the step of grit blasting the surface of the substrate to increase surface roughness prior to treating the surface of the substrate with a water jet.

26. A method according to claim 24, wherein the step of depositing a third coating layer onto the modified surface of the second metallurgical coating layer includes deposition of a ceramic coating layer onto the modified surface of the second metallurgical coating layer by plasma thermal spray.

27. A method according to claim 26, wherein the step of depositing a third coating layer includes deposition of a 6-8 weight % Yttria stabilized zirconium oxide ceramic thermal barrier coating over the modified surface the second metallurgical coating layer.

28. A method according to claim 24, wherein the deposition of at least one of the first and second metallurgical coating layers includes the step of depositing a platinum aluminide metallurgical coating.

29. A method according to claim 24, wherein the deposition of at least one of the first and second metallurgical coating layers includes the step of depositing a MCrAlY metallurgical coating, wherein M is selected from the group consisting of Co, Ni and NiCo.

30. A method according to claim 24, further comprising the step of vacuum heat treating the coated substrate prior to deposition of the second coating layer.

31. A method according to claim 30, further comprising the step of subjecting the coated substrate to hot isostatic pressing prior to deposition of the second coating layer.

32. A gas turbine component made by a process comprising the steps of:
a) providing a gas turbine component defining a superalloy substrate;
b) directing a water jet having a sufficient pressure against the surface of the superalloy substrate for a sufficient time period to modify the surface morphology of the substrate; and
c) depositing a metallurgical coating layer onto the modified surface of the substrate by high velocity oxygen fuel spray.

33. A gas turbine component made by a process comprising the steps of:
a) providing a gas turbine component defining a superalloy substrate;
b) roughening the surface of the substrate through grit blasting;
c) directing a water jet having a sufficient pressure against the roughened surface of the substrate for a sufficient time period to modify the surface morphology of the substrate; and
d) depositing a metallurgical coating on the modified surface of the substrate by high velocity oxygen fuel spray.
